(19) United States
(12) Patent Application Publication
(10) Pub. No.: US 2011/0304658 A1
(43) Pub. Date: Dec. 15, 2011

(54) STEREOSCOPIC IMAGE DISPLAY AND DRIVING METHOD THEREOF

(76) Inventors: Jong Myoung Park, Seoul (KR); Sang Ok Yeo, Seoul (KR); Gi Seok Lee, Seoul (KR); Yun Mi Lee, Seoul (KR); Se Kyu Lee, Seoul (KR); Seong Hong Park, Seoul (KR)

(21) Appl. No.: 13/127,134

(22) PCT Filed: Nov. 18, 2009
(86) PCT No.: PCT/KR2009/006788

§ 371 Date: Aug. 30, 2011

(30) Foreign Application Priority Data
Nov. 18, 2008 (KR) 10-2008-0114574
Sep. 23, 2009 (KR) 10-2009-0090073

(51) Int. Cl. G09G 3/36; G09G 5/02; G09G 5/10

(52) U.S. Cl. 345/691; 345/88

(57) ABSTRACT

The present invention relates to a stereoscopic image display and to a driving method thereof, and more particularly, to a stereoscopic image display capable of preventing the occurrence of crosstalk, and to a driving method thereof. The method for driving the stereoscopic image display of the present invention, comprises the steps of: generating a double-speed image signal containing a left eye image signal and a right eye image signal having a period shorter than one frame of input frame units, and a black image signal with no scene signal for image signals input by said frame units which separately contain a left eye image and a right eye image; and outputting a driving signal for driving a display panel in accordance with the double-speed image signal.

### BACKGROUND OF THE INVENTION

1. Field of the Invention

The present invention relates to a 3-dimensional image display and a driving method thereof, and more particularly, to a 3-dimensional image display which can prevent the occurrence of crosstalk, and a driving method thereof.

2. Discussion of the Related Art

With recent advances in digital display technology, new displays have been introduced which are capable of displaying realistic, 3-dimensional (3D) images in addition to displaying high-definition images on a large screen, thereby satisfying consumer demand.

Large-screen 3D image displays developed up to now include a polarization type and a parallax barrier type. Especially, the polarization type does not deteriorate resolution of images unlike the parallax barrier type.

The polarization type 3D image display includes an active shutter glasses type in which an active shutter is applied to glasses and a passive glasses type using polarized glasses.

The active shutter type generates parallax using a liquid crystal shutter in glasses over time with respect to a left-eye image and a right-eye image. The passive glasses type generates different polarized signals over time by installing a liquid crystal element in a display and displays alternately left-eye and right-eye images using polarized glasses.

A device for displaying left-eye and right-eye images over time includes a micro display (LCD, LCoS, DLP, etc.) and a direct view display (CRT, LCD, PDP, etc.).

### SUMMARY OF THE INVENTION

Accordingly, the present invention is directed to a 3D image display which can reduce mutual interference between a left-eye image and a right-eye image by a double-speed image signal having a black image signal interval upon generating a 3D image signal, and a driving method thereof.

Additional advantages, objects, and features of the invention will be set forth in part in the description which follows and in part will become apparent to those having ordinary skill in the art upon examination of the following or may be learned through practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for driving a three-dimensional image display includes generating a double-speed image signal including a black image signal with no screen signals and including left-eye and right-eye image signals having a shorter period than one frame, with respect to an input image signal in units of frames, wherein the input image signal separately contains a left-eye image and a right-eye image, and generating a driving signal for driving a display panel by the double-speed image signal.

In another aspect of the present invention, a three-dimensional image display includes a driving signal processor for generating a double-speed image signal including a black image signal with no screen signals and including left-eye and right-eye image signals having a period shorter than one frame, with respect to an input image signal in units of frames, wherein the input image signal separately contains a left-eye image and a right-eye image, and a display panel driven by a driving signal generated from the driving signal processor.

In a further aspect of the present invention, a three-dimensional image display includes a driving signal processor for generating a double-speed image signal and an inverted driving signal with respect to an input image signal, generating a double-speed image signal by doubling the input image signal to the same signal upon generating a two-dimensional image signal, and generating a double-speed image signal including a black image signal between a left-eye image signal and a right-eye image signal upon generating a three-dimensional image signal.

In still another aspect of the present invention, a three-dimensional image display includes a light source, a Polarization Beam Splitter (PBS) for controlling a path of light emitted from the light source, a display panel having a black image signal between a left-eye image signal and a right-eye image signal to achieve a three-dimensional image, wherein light passing through the PBS is incident on the display panel and wherein the display panel is driven by a driving signal having an inverted signal at a period of sum of the left-eye image signal and the right-eye image signal, and a projection lens for projecting an image achieved by the display panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a display;

FIGS. 2a to 2e illustrate an example of driving signal waveforms of a display panel;

FIGS. 3a to 3e illustrate an example of driving signal waveforms of a 3D image;

FIG. 4 is a graph illustrating liquid crystal response signals;

FIG. 5 is a graph illustrating the occurrence of crosstalk caused by the signals shown in FIG. 4;

FIGS. 6a to 6f illustrate another example of driving signal waveforms of a 3D image;

FIG. 7 is a graph illustrating liquid crystal response signals;

FIG. 8 is a graph illustrating the occurrence of crosstalk caused by the signals shown in FIG. 7;

FIG. 9 is a schematic diagram illustrating an exemplary embodiment of a 3D display; and

FIG. 10 is a diagram illustrating implementation of 3D image.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

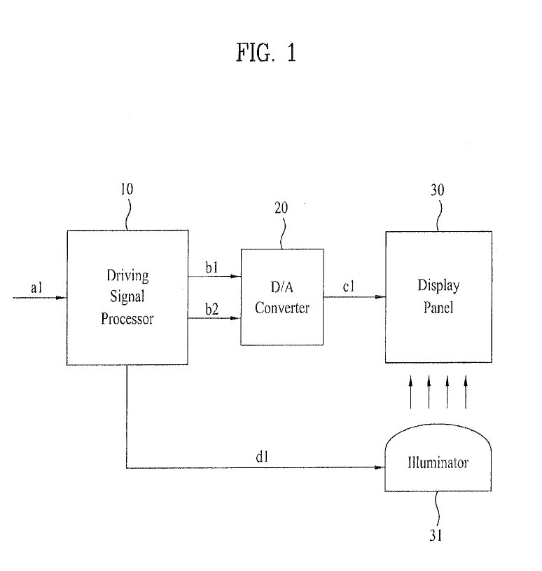

As illustrated in FIG. 1, a driving signal processor of a display receives an input signal a1 which separately includes a left-eye image and a right-eye image to achieve a 3D image, or an input image signal which is input after signal processing is performed in the display.

Upon receiving the input image signal a1, the driving signal processor 10 generates a double-speed image signal b1 and an inverted driving signal b2. The double-speed image signal b1 is obtained by doubling the same frame so that the input image signal a1 can be driven at double speed for the purpose of frame inversion to avoid an after image of a display panel 30. The inverted driving signal b2 serves to determine inversion polarity for frame inversion. Hereinafter, an LCD panel is described as an example of the display panel 30.

The double-speed image signal b1 and the inverted driving signal b2, which are digital signals generated from the driving signal processor 10, are input to a Digital/Analog (D/A) converter 20. The D/A converter 20 then generates a liquid crystal driving signal c1, which is an analog signal, to drive the display panel 30.

The LCD panel 30 includes an illuminator 31 (usually, referred to as a backlight) for supplying light to the LCD panel 30. The driving signal processor 10 generates an illumination control signal d1 which can control the timing at which light generated from the illuminator 31 is irradiated to the LCD panel 30.

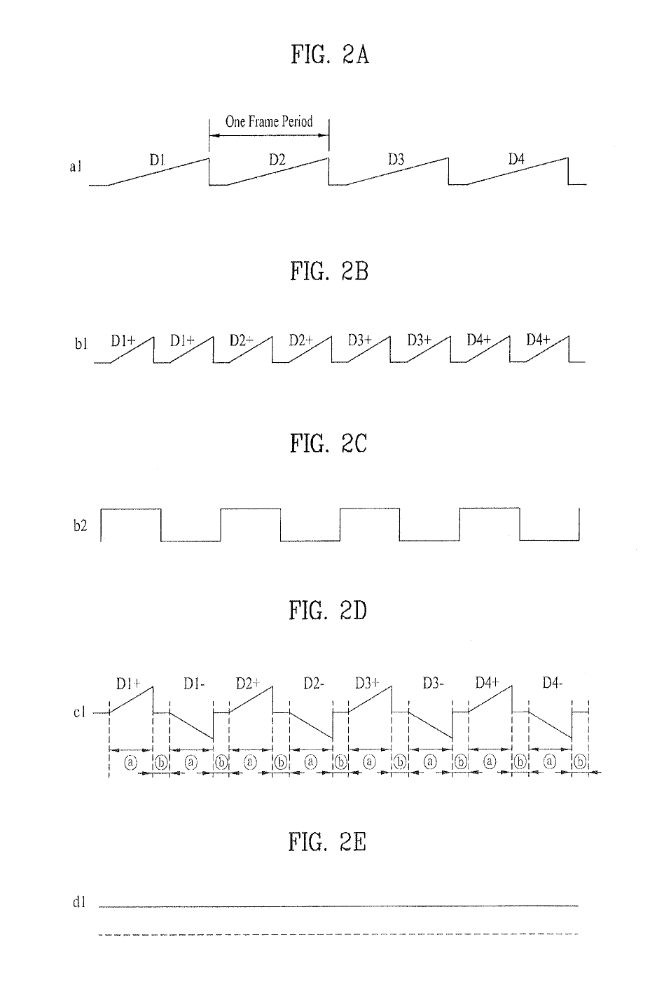

Waveforms of output signals generated through the above process are illustrated in FIGS. 2a to 2e. Namely, if an input image signal a1 is input to the driving signal processor 10 in units of frames, the driving signal processor 10 generates a double-speed image signal b1, a period of which is half a period of the input image signal a1 in one frame, and generates an inverted driving signal b2 for inverting the same signals within one frame.

In the input image signal a1, reference symbols D1, D2, . . . denote images of respective frames and the respective frame images are comprised of the double-speed image signal b1 having the same double-speed signals D1+, D2+, . . . .

A liquid crystal driving signal c1 is obtained by multiplying the double-speed image signal b1 by the inverted driving signal b2. The liquid crystal driving signal c1 is comprised of image signals D1+, D1−, D2+, . . . , each being double the rate of the input image signal and having opposite polarities.

Thus, the liquid crystal driving signal c1 may solve an after image problem in the LCD panel by driving the display using image signals having opposite polarities.

In this case, an illumination control signal d1 of an always high state is generated and the illuminator 31 may remain on at all times.

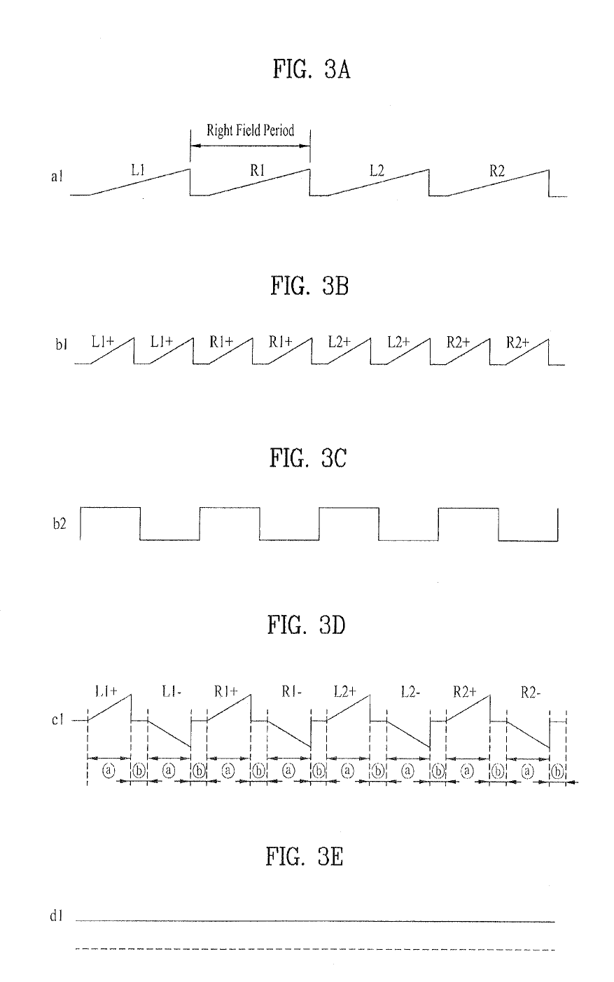

Meanwhile, a 3D image has an input image signal a1 comprised of left-eye images (L1, L2, etc.) and right-eye images (R1, R2, etc.) in units of frames. The 3D image generates output waveforms as illustrated in FIGS. 3a to 3e through the above-described process.

Specifically, the left-eye images (L1, L2, etc.) alternate with the right-eye images (R1, R2, etc.) as shown in FIG. 3a. The alternating image signals are generated as a double-speed image signal b1 including the same double-speed signals (L1+, L1+, R1+, R1+, etc.) as shown in FIG. 3b. The double-speed image signal b1 is generated as a liquid crystal driving signal c1 as shown in FIG. 3d by multiplication with an inverted driving signal b2 shown in FIG. 3c. The liquid crystal driving signal c1 is comprised of inverted image signals (L1+, L1−, R1+, R1−, etc.).

In this case, an illumination control signal d1 is always in a high state so that the illuminator 31 may always remain an on state.

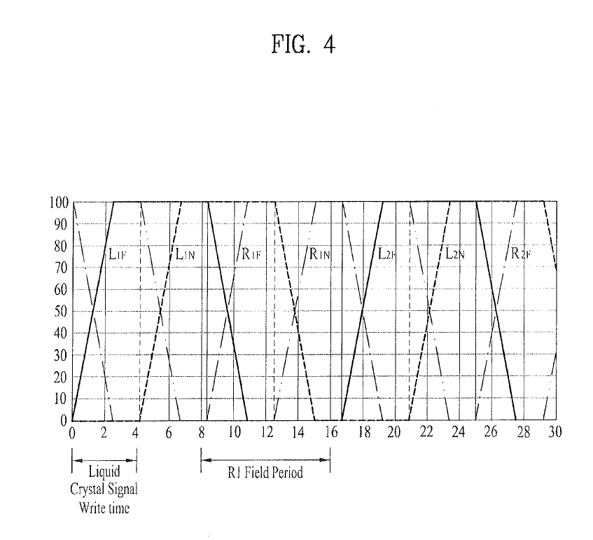

FIG. 4 shows times written into the first pixel and the last pixel of a display panel and liquid crystal response signals of the two pixels in a full High Definition (HD) (1080 pixels) LCD when a frame rate of the 3D input image signal a1 is 60 Hz, and a frame rate of each of a left-eye image and a right-eye image is 120 Hz.

Hereinafter, a display characteristic is described in the case of achieving a 3D image in a display panel having such liquid crystal response signals. To this end, image signals of only the first pixel and the last pixel of the display panel are shown for convenience because the display characteristic is sufficiently predicted when the 3D image is displayed in the display panel only by the images of the first and last pixels.

Referring to FIG. 4, solid lines denote liquid crystal brightness signals by the left-eye images (L1, L2, etc.) in the first pixel of the display panel, and dotted lines denote liquid crystal brightness signals by the left-eye images (L1, L2, etc.) in the last pixel.

In addition, dash-dotted lines denote liquid crystal brightness signals by the right-eye images (R1, R2, etc.) in the first pixel of the display panel and dash-dot-dotted lines denote liquid crystal brightness signals by the right-eye images (R1, R2, etc.) in the last pixel.

More specifically, L1F denotes a liquid crystal brightness signal in the first pixel of the display panel by the signal L1, and L1N denotes a liquid crystal brightness signal in the last pixel of the display panel by the signal L1.

Similarly, R1F denotes a liquid crystal brightness signal in the first pixel of the display panel by the signal R1, and R1N denotes a liquid crystal brightness signal in the last pixel of the display panel by the signal R1.

As shown, the signal L1N is started after a liquid crystal signal write time since the signal L1F has been started. A field period of the signal L1 or R1 for displaying the left-eye or right-eye image may be twice the liquid crystal signal write time.

In terms of LCD properties, a response time is needed until full brightness is realized when a liquid crystal signal is enabled and the response time is also needed for liquid crystal to fully darken when the liquid crystal signal is disabled.

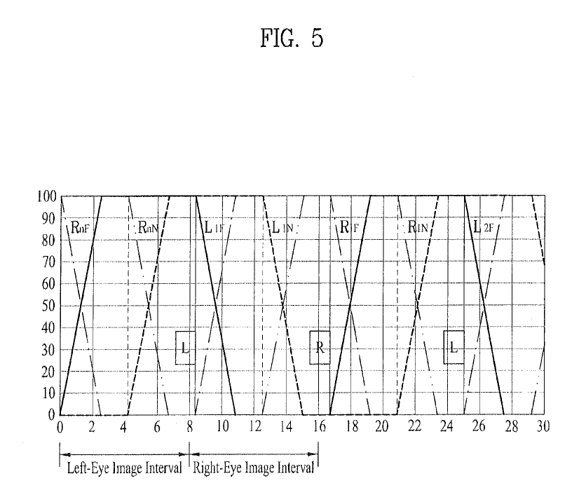

Accordingly, as shown in FIG. 5, when a 3D image is achieved in an LCD, crosstalk indicating that a left-eye image interval and a right-eye image interval interfere with each other may be generated.

In FIG. 5, reference symbol RnF denotes a right-eye image signal of the first pixel of a previous screen invading on a left-eye image interval. RnN denotes a right-eye image signal of the last pixel of a previous screen invading on a left-eye image interval. That is, crosstalk that the right-eye image signals RnF and RnN are present in the left-eye image interval may occur. A left-eye image signal area with no crosstalk in the left-eye image interval occupies only a part indicated by ‘L’.

Similarly, reference symbol L1F denotes a left-eye image signal of the first pixel, which has been enabled in the left-eye image interval, invading on a right-eye image interval by a disabled signal. L1N denotes a left-eye image signal of the last pixel invading on the right-eye image interval. A right-eye image signal area with no crosstalk in the right-eye image interval is indicated by ‘R’.

As described above, due to the liquid crystal response time and the time for writing an image signal into the display, the right-eye image signal may invade on the left-eye image interval and the left-eye image signal may invade on a right-eye image interval. When realizing a 3D image using a left-eye and right-eye time difference in an LCD, considerable crosstalk may be generated due to the liquid crystal signal write time as well as due to the response speed of liquid crystal.

To improve such a phenomenon, it is favorable to use the driving signals shown in FIGS. 2a to 2e when achieving a 2D image signal by an LCD, and to use the following driving signals when achieving a 3D image signal by the LCD.

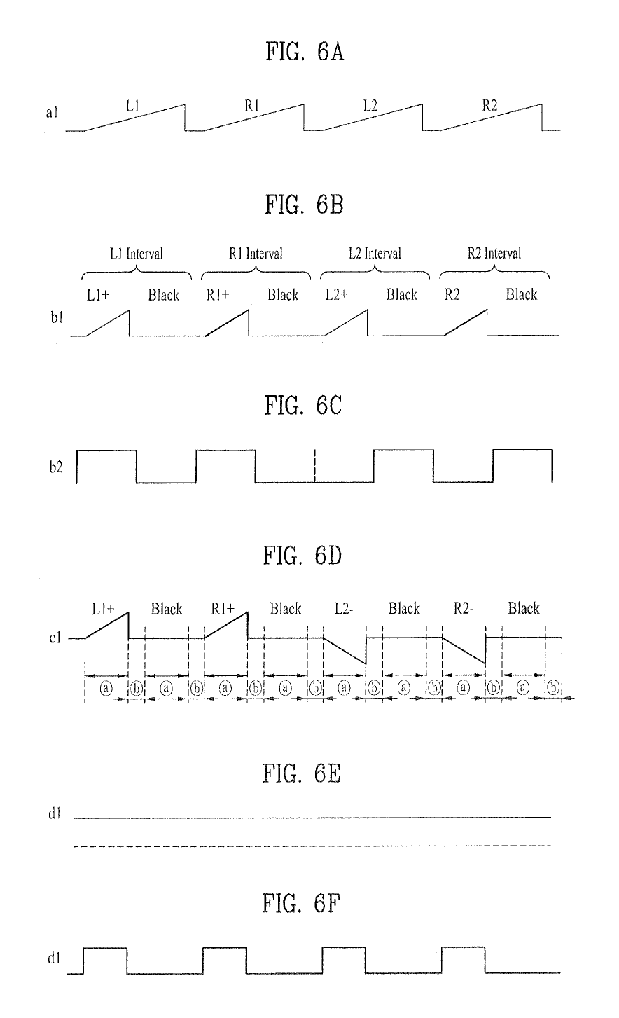

That is, left-eye image signals (L1, L2, etc.) and right-eye image signals (R1, R2, etc.) are alternately located in an input image signal a1 as shown in FIG. 6a. The alternating signals are generated as a double-speed image signal b1 including a black image signal having no screen signal in each period.

The period of the double-speed image signal b1 may be ½ the period of the input image signal a1. That is, the speed of the double-speed image signal b1 may be twice the speed of the input image signal a1. However, the double-speed image signal b1 may be a signal of 3 times, 1.5 times, etc. the input image signal a1.

As described above, the double-speed image signal b1 includes the black image signal in each period. Although, in FIG. 6b, the image signal has the same duration as the black image signal, they may have different durations. For example, the length of the black image signal may be longer or shorter than the length of the left-eye or right-eye image signal.

Thus, an L1 interval includes an L1+ signal and a black signal, and an R1 interval includes an R1+ signal and a black signal. Similarly, an L2 interval includes an L2+ signal and a black signal, and an R2 interval includes an R2+ signal and a black signal.

The driving signal processor 10 generates an inverted driving signal b2 for frame inversion. The inverted driving signal b2 has a period of sum of a pair of a left-eye image signal and a right-eye image signal constituting one image.

That is, the period of the inverted driving signal b2 is changed after the L1+ signal and R1+ signal.

Accordingly, a panel driving signal c1 includes an L1+ signal, a black signal, an R1+ signal and a black signal of one period. From an L2− signal, inverted signals are generated during the same length of one period. Again, normal signals (non-inverted signals) are generated after one period.

In the driving signal c1, an interval \textcircled{a} denotes an active interval during which the driving signal is written into liquid crystal, and an interval \textcircled{b} denotes a dummy interval during which writing is not performed.

As shown in FIG. 6e, an illumination control signal d is always in a high state so that the illuminator 31 may remain on state at all times.

However, in the above case, the same function may be performed by turning off the illuminator 31 in a black image signal interval.

That is, illumination may be turned off while the black signal shown in FIG. 6d is generated. Meanwhile, even when the same double-speed signal is generated without generating the black signal as shown in FIG. 3d, the occurrence of crosstalk may be suppressed by turning off the illumination while at least one double-speed signal is generated.

Namely, as shown in FIG. 6f, even when the same double-speed signal is generated without generating the black signal, the occurrence of crosstalk may be suppressed by turning off illumination by the illuminator 31 in an interval during which a subsequent double-speed signal is generated.

Thus, at a prescribed part of the double-speed image signal, for example, at a part where a subsequent double-speed signal is generated, the illumination may be turned off. In this case, in an illumination off interval, the black signal may be generated or the double-speed signal may be generated.

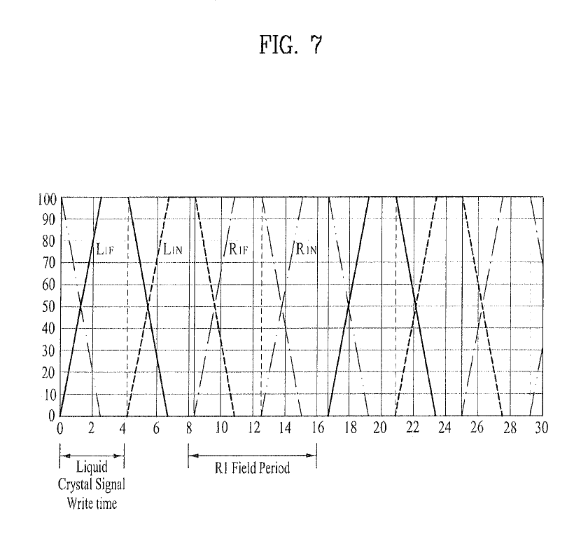

FIG. 7 shows input times of signals written into the first pixel and the last pixel of a display panel in an LCD and liquid crystal response signals of the two pixels.

In FIG. 7, L1F denotes a liquid crystal brightness signal of the first pixel by the signal L1, and L1N denotes a liquid crystal brightness signal of the last pixel by the signal L1. Similarly, R1F denotes a liquid crystal brightness signal of the first pixel by the signal R1, and R1N denotes a liquid crystal brightness signal of the last pixel by the signal R1.

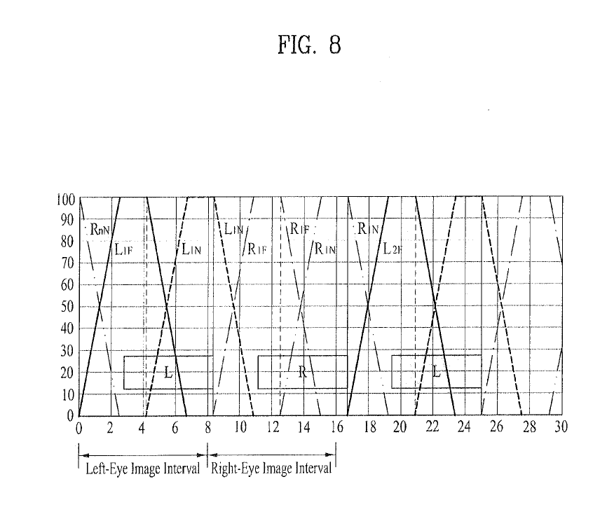

It can be seen in FIG. 7 that an interval between the liquid crystal brightness signals becomes wider. Accordingly, as shown in FIG. 8, crosstalk due to a liquid crystal signal write time is eliminated and only crosstalk due to a liquid crystal response speed remains, thereby remarkably reducing an area where crosstalk between the left-eye image and right-eye image occurs.

In FIG. 8, a part indicted by ‘L’ denotes a left-eye image signal area having no crosstalk in a left-eye image interval, and a part indicated by ‘R’ denotes a right-eye image signal area having no crosstalk in a right-eye image interval. As shown, an area where crosstalk occurs is remarkably reduced.

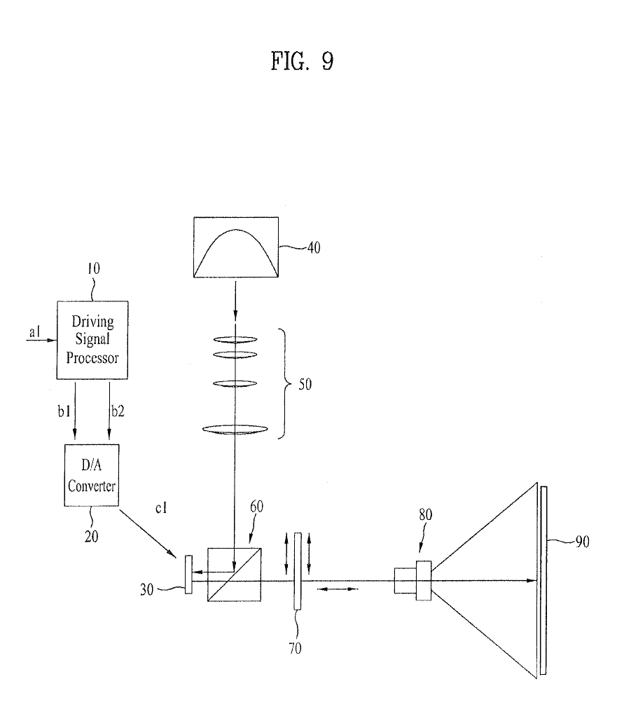

As an exemplary embodiment of a 3D image display realized by the above-described method, a liquid crystal projection display (an LCD, LCoS, etc.) is shown in FIG. 9.

In the projection display which can achieve a 3D image, light emitted from a light source 40 is incident on a Polarization Beam Splitter (PBS) 60 by an illumination lens group 50. The light which is incident on the PBS 60 forms an image by a display panel 30 which is driven by an output driving signal c1 generated through a driving signal processor 10 and the D/A converter 20, and is projected onto a screen 90 through a projection lens 80.

The output driving signal c1 drives the display panel 30 through the following process.

First, the driving signal processor 10 receives an input signal a1 which separately includes a left-eye image and a right-eye image to achieve a 3D image, or an input image signal which is input after signal processing is performed in the display.

The driving signal processor 10 generates a double-speed image signal b1 by doubling the same frame of the input image signal a1 of the display panel 30. A black image signal is located between each left-eye image and each right-eye image constituting one scene.

The driving signal processor 10 also generates an inverted driving signal b2 which serves to determine inversion polarity and has a period of sum of the left-eye image and the right-eye image.

The double-speed image signal b1 and the inverted driving signal b2, which are digital signals generated from the driving signal processor 10, are input to the D/A converter 20. The D/A converter 20 then generates a liquid crystal driving signal c1, which is an analog signal, to drive the display panel 30.

The polarization conversion cell 70 polarizes the left-eye image and right-eye image generated from the display panel 30 so as to achieve different polarized states. A liquid crystal panel may be used as the polarization conversion cell 70.

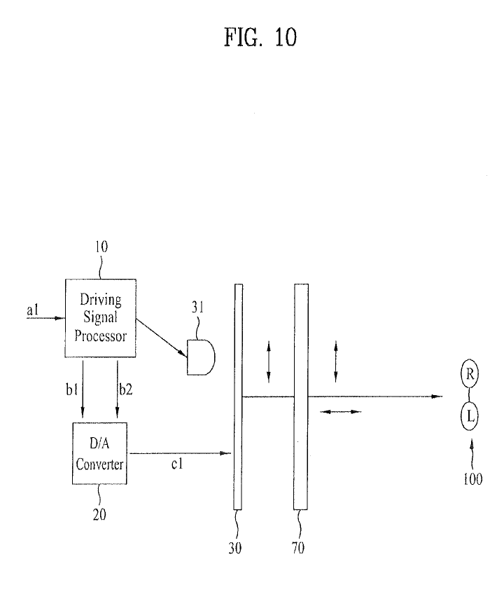

Namely, as shown in FIG. 10, the left-eye image and the right-eye image generated from the display panel 30 have different polarized states by the polarization conversion cell 70 and viewers can view a 3D image through polarized glasses 100 including a left-eye glass L and a right-eye glass R corresponding to the two different polarized states.

Accordingly, the left-eye image and the right-eye image generated from the display panel 30 can be independently seen through the left-eye glass L and the right-eye glass R of the polarized glasses 100, thereby producing a stereoscopic image.

Meanwhile, upon generating the double-speed image signal and the inverted driving signal with respect to the input image signal, the display may generate different double-speed image signals and the inverted driving signal when generating a 2D image signal and when generating a 3D image signal.

Namely, the driving signal processor 10 may be controlled to generate a double-speed image signal by doubling the input image signal to the same signal when generating the 2D image signal, and to generate a double-speed image signal including a black image signal between a left-eye image signal and a right-eye image signal when generating the 3D image signal.

Meanwhile, when the display panel 30 receives light generated from an illuminator 31, the illuminator 31 may turn off illumination in an interval during which the black image signal is generated and a normal double-speed image signal may be generated instead of the black image signal in this interval.

In this case, it is favorable for the driving signal processor 10 to generate an inverted image signal having a period of sum of the left-eye image signal and the right-eye image signal upon generating the 3D image signal.

An LCD panel may be used as the display panel 30, and the display panel 30 is applicable to all devices using LCD panels such as LCD TVs, monitors, etc.

The present invention uses a liquid crystal driving signal including a black signal to reduce interference between a left-eye image and a right-eye image caused by slow write speed, thereby realizing a high-quality 3D image.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for driving a three-dimensional image display, comprising:
generating a double-speed image signal including a black image signal with no screen signals and including left-eye and right-eye image signals having a shorter period than one frame, with respect to an input image signal in units of frames, wherein the input image signal separately contains a left-eye image and a right-eye image; and
generating a driving signal for driving a display panel by the double-speed image signal.

2. The method of claim 1, further comprising, after the generating of the double-speed image signal, generating an inverted image signal for inverting the left-eye image signal or the right-eye image signal.

3. The method of claim 2, wherein the inverted image signal has a period of sum of a pair of the left-eye image signal and the right-eye image signal.

4. The method of claim 1, wherein the driving signal includes an active interval during which the display panel is driven by the left-eye image signal or the right-eye image signal and a dummy interval during which the display panel is not driven.

5. The method of claim 1, wherein a period of the double-speed image signal is ½ a period of the input image signal.

6. The method of claim 1, wherein the left-eye image signal, the right-eye image signal, and the black image signal have the same length.

7. The method of claim 1, wherein the black image signal is located between the left-eye image signal and the right-eye image signal.

8. The method of claim 1, further comprising generating an illumination control signal for controlling illumination irradiated to the display panel according to the double-speed image signal.

9. The method of claim 8, wherein the generating of the illumination control signal includes generating a signal for turning off illumination in an interval during which the black image signal of the double-speed image signal is generated.

10. A method for driving a three-dimensional image display, comprising:
generating a double-speed image signal including left-eye and right-eye image signals having a shorter period than one frame, with respect to an input image signal in units of frames, wherein the input image signal separately contains a left-eye image and a right-eye image;
generating a driving signal for driving a display panel by the double-speed image signal; and
generating an illumination control signal for turning off illumination at a period corresponding to at least one signal constituting the double-speed image signal.

11. A three-dimensional image display, comprising:
a driving signal processor for generating a double-speed image signal including a black image signal with no screen signals and including left-eye and right-eye image signals having a period shorter than one frame, with respect to an input image signal in units of frames, wherein the input image signal separately contains a left-eye image and a right-eye image; and
a display panel driven by a driving signal generated from the driving signal processor.

12. The three-dimensional image display of claim 11, wherein the display panel includes a digital/analog converter for generating a driving signal to drive the display panel by the double-speed image signal.

13. The three-dimensional image display of claim 11, further comprising a polarization filter located at the front of the display panel, for converting the left-eye image and the right-eye image into a first polarized state and a second polarized state, respectively, which are perpendicular to each other.

14. The three-dimensional image display of claim 11, wherein the driving signal processor generates an inverted image signal for inverting the left-eye image signal or the right-eye image signal after generating the double-speed image signal.

15. The three-dimensional image display of claim 11, wherein the display panel is a liquid crystal display panel.

16. The three-dimensional image display of claim 11, wherein the driving signal processor generates an illumination control signal for turning off illumination of the liquid crystal display panel in an interval during which the black image signal is generated.

17. A three-dimensional image display comprising:
a driving signal processor for generating a double-speed image signal and an inverted driving signal with respect to an input image signal, generating a double-speed image signal by doubling the input image signal to the same signal upon generating a two-dimensional image signal, and generating a double-speed image signal including a black image signal between a left-eye image signal and a right-eye image signal upon generating a three-dimensional image signal.

18. The three-dimensional image display of claim 17, wherein the driving signal processor generates an inverted image signal having a period of sum of the left-eye image signal and the right-eye image signal of the double-speed image signal upon generating the three-dimensional image signal.

19. The three-dimensional image display of claim 17, wherein the driving signal processor generates an illumination control signal for turning off illumination of the display in an interval during which the black image signal is generated.

20. A three-dimensional image display comprising:
a light source;
a Polarization Beam Splitter (PBS) for controlling a path of light emitted from the light source;
a display panel having a black image signal between a left-eye image signal and a right-eye image signal to achieve a three-dimensional image, wherein light passing through the PBS is incident on the display panel and wherein the display panel is driven by a driving signal having an inverted signal at a period of sum of the left-eye image signal and the right-eye image signal; and
a projection lens for projecting an image achieved by the display panel.

21. A three-dimensional image display, comprising:
a driving signal processor for generating a double-speed image signal including left-eye and right-eye image signals having a period shorter than one frame, with respect to an input image signal in units of frames, wherein the input image signal separately contains a left-eye image and a right-eye image, and generating an illumination control signal for turning off illumination at a period corresponding to at least one signal constituting the double-speed image signal.

22. A three-dimensional image display comprising:
a driving signal processor for generating a double-speed image signal and an inverted driving signal with respect to an input image signal, generating a double-speed image signal by doubling the input image signal to the same signal upon generating a two-dimensional image signal, generating a double-speed image signal by doubling a left-eye image signal and a right-eye image signal to the same signals upon generating a three-dimensional image signal, and generating an illumination control signal for turning off illumination at a period corresponding to at least one signal constituting the double-speed image signal.

23. A three-dimensional image display comprising:
a light source;
a Polarization Beam Splitter (PBS) for controlling a path of light emitted from the light source;
a display panel having a double-speed image signal by doubling a left-eye image signal and a right-eye image signal to the same signals to achieve a three-dimensional image, wherein light passing through the PBS is incident on the display panel and wherein the display panel is driven by a driving signal having an inverted signal at a period of sum of the left-eye and right-eye image signals;
an illuminator for supplying illumination to the display panel and turning off illumination at a period corresponding to at least one signal constituting the double-speed image signal; and
a projection lens for projecting an image achieved by the display panel.
